(19) United States
(12) Patent Application Publication
(10) Pub. No.: US 2019/0187296 A1
(43) Pub. Date: Jun. 20, 2019

(54) METHOD AND SYSTEM FOR PROCESSING TRAJECTORY DATA

(71) Applicant: Pusan National University Industry-University Cooperation Foundation, Busan (KR)

(72) Inventors: Hye Rim BAE, Busan (KR); Iq Reviessay PULSHASHI, Busan (KR); Yu Lim CHOI, Busan (KR); Riska Asriana SUTRISNOWATI, Busan (KR)

(73) Assignee: Pusan National University Industry-University Cooperation Foundation, Busan (KR)

(21) Appl. No.: 16/223,113

(22) Filed: Dec. 18, 2018

(30) Foreign Application Priority Data
Dec. 19, 2017 (KR) 10-2017-0175245

(51) Int. Cl. G01S 19/42; G01S 19/40

(52) U.S. Cl. CPC G01S 19/42; G01S 19/40

(57) ABSTRACT

Disclosed is a trajectory data processing method and system. The trajectory data processing method includes, in response to a smoothing instruction related to a trajectory of a moving object being generated by a web application server, identifying trajectory data associated with the trajectory, smoothing the trajectory by applying a selected algorithm to the trajectory data, and providing the web application server with a smoothed trajectory generated by the smoothing.

### CROSS-REFERENCE TO RELATED APPLICATION(S)

This application claims the priority benefit of Korean Patent Application No. 10-2017-0175245 filed on Dec. 19, 2017, in the Korean Intellectual Property Office, the disclosure of which is incorporated herein by reference for all purposes.

### BACKGROUND

### 1. Field of the Invention

One or more example embodiments relate to a trajectory data processing method and system that may minimize noise and improve an outlier detection performance by smoothing a trajectory of a moving object.

### 2. Description of the Related Art

In general, in a large ship-building industrial complex, trucks or loads move continuously for ship manufacturing. To promote the efficiency of a ship manufacturing process, trajectories of such moving objects need to be identified accurately.

Meanwhile, in a case of generating a trajectory based on trajectory data in which positions of a moving object are recorded at predetermined intervals, a complex and inaccurate trajectory including a sudden movement to a point at a distance which cannot be reached for a short time in reality or including a movement repeatedly circling around a predetermined point may be generated due to a variety of noise and outliers occurring during a process of measuring or transmitting position information. Thus, it may be difficult to accurately identify an actual trajectory of a moving object using input trajectory data as it is without analyzing the input trajectory data.

Accordingly, there have been suggested a number of algorithms to simplify a trajectory of a moving object by eliminating noise and outliers included in a dataset (that is, trajectory data) related to positions of the object.

However, existing algorithms are limited to simplifying trajectory data input in a form of batch and thus have relatively low accuracy and precision. It may be difficult to generate an accurate trajectory in real time with respect to trajectory data input in a form of streaming through the existing algorithms.

Accordingly, there is a desire for technology for increasing an accuracy of a trajectory by removing noise from trajectory data in which positions of a moving object are recorded, and for securing a sufficient precision through an analysis considering a trajectory data collecting form.

### SUMMARY

An aspect is directed to smoothing a trajectory of a moving object by applying a selected trajectory smoothing algorithm to trajectory data in which positions of a moving object are recorded at predetermined intervals, thereby increasing a precision of the trajectory.

Another aspect is also directed to minimizing minute noise, which is difficult to detect using an existing outlier detection algorithm, by smoothing a trajectory, thereby more improving an outlier detection performance through the outlier detection algorithm.

Still another aspect is also directed to smoothing trajectory data in view of a data collecting form (for example, a batch or streaming), thereby precisely identifying a trajectory of a moving object.

According to an aspect, there is provided a trajectory data processing method including, in response to a smoothing instruction related to a trajectory of a moving object being generated by a web application server, identifying trajectory data associated with the trajectory, smoothing the trajectory by applying a selected algorithm to the trajectory data, and providing the web application server with a smoothed trajectory generated by the smoothing.

According to another aspect, there is provided a trajectory data processing system including, in response to a smoothing instruction related to a trajectory of a moving object being generated by a web application server, an interface configured to identify trajectory data associated with the trajectory, and a processor configured to smooth the trajectory by applying a selected algorithm to the trajectory data, and provide the web application server with a smoothed trajectory generated by the smoothing.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a configuration of a trajectory data processing system according to an example embodiment;

FIGS. 2A and 2B illustrate examples of algorithms for smoothing trajectory data in a trajectory data processing system according to an example embodiment;

FIG. 3 illustrates an example of smoothing trajectory data in a trajectory data processing system according to an example embodiment;

FIG. 4 illustrates an example of smoothing trajectory data in a trajectory data processing system according to an example embodiment;

FIGS. 5A and 5B illustrate an example of detecting an outlier in a trajectory data processing system according to an example embodiment;

FIGS. 6A through 6C illustrate an example of detecting an outlier in a trajectory data processing system according to an example embodiment; and

FIG. 7 is a flowchart illustrating a trajectory data processing method according to an example embodiment.

### DETAILED DESCRIPTION

Hereinafter, example embodiments will be described in detail with reference to the accompanying drawings. The scope of the right, however, should not be construed as limited to the example embodiments set forth herein. Like reference numerals in the drawings refer to like elements throughout the present disclosure.

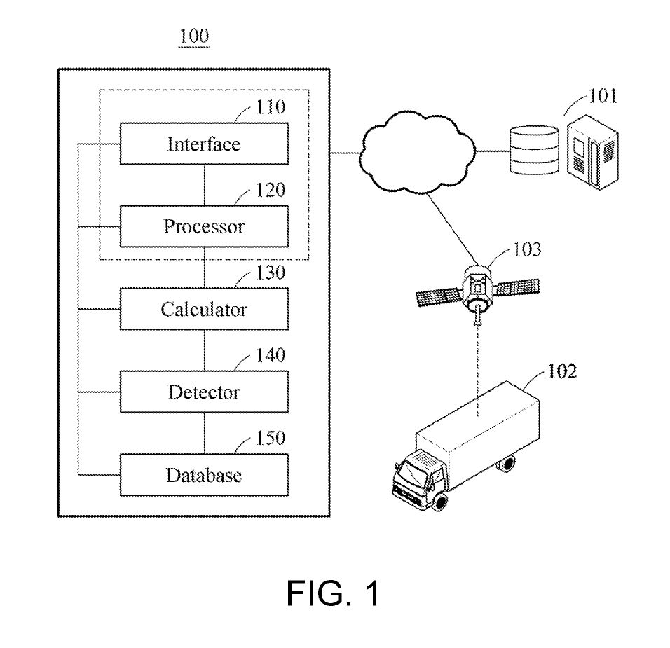

FIG. 1 is a diagram illustrating a configuration of a trajectory data processing system according to an example embodiment.

Referring to FIG. 1, a trajectory data processing system 100 may include an interface 110 and a processor 120. In an example, the trajectory data processing system 100 may further include a calculator 130, a detector 140, and a database 150.

In response to a smoothing instruction related to a trajectory of a moving object 102 being generated by a web application server 101, the interface 110 may identify trajectory data associated with the trajectory.

Here, the smoothing instruction refers to an instruction to generate a smoothed trajectory by removing noise included in the trajectory through smoothing.

For example, the interface 110 may receive, from the web application server 101, the trajectory data in which positions measured at predetermined intervals are recorded as the object 102 moves.

Herein, the object 102 may be, for example, a means of transportation such as a truck that travels to transport goods. The web application server 101 may refer to a server which provides an administrator with a web page to monitor the trajectory of the object 102.

The web application server 101 may track positions of the moving object 102 through a GPS receiver attached to the object 102, through interoperation with a global positioning system (GPS) 103, and provide the trajectory data by recording the tracked positions at predetermined time intervals. Further, the web application server 101 may also provide the trajectory data by tracking positions of a mobile terminal carried by a driver on the object 102.

The trajectory data may be a dataset in which positions (for example, position coordinates, latitude, and longitude) measured at predetermined intervals are recorded as the object 102 moves. Each data of the trajectory data may be recorded in a form of (time of measurement, latitude, longitude) at predetermine intervals (for example, “5”-second intervals).

The web application server 101 may generate the smoothing instruction while inputting the trajectory data into the trajectory data processing system 100. That is, the interface 110 may identify the trajectory data input from the web application server 101 in a form of batch along with the smoothing instruction.

In detail, the interface 110 may verify the trajectory data, in which positions measured at predetermined intervals are recorded as the object 102 moves, input from the web application server 101, and configure the trajectory to be smoothed to include movement points identified based on the trajectory data.

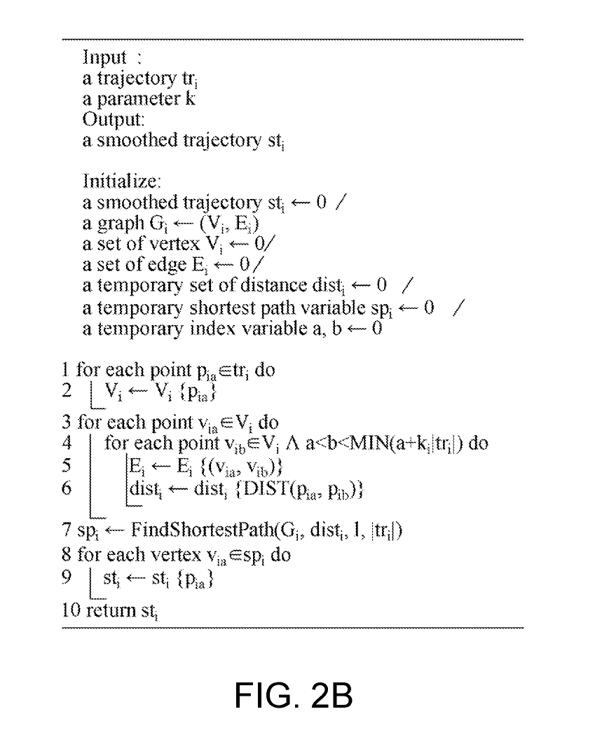

For example, referring to FIG. 3, the interface 110 may configure a trajectory to be smoothed by arranging “23” movement points by time of measurement based on each data (time of measurement, latitude, longitude) recorded at “5”-second intervals in the trajectory data.

Further, the interface 110 may receive the trajectory data in real time from the GPS 103 through the GPS receiver attached to the object 102.

That is, the interface 110 may receive trajectory data in a form of batch, in which positions of the moving object 102 are recorded, from the web application server 101 in a batch, or receive trajectory data including a real-time position of the object 102 designated by the web application server 101 from the GPS 103 in a streaming environment and configure a trajectory.

The processor 120 may smooth the trajectory by applying a selected algorithm to the trajectory data, and provide the web application server 101 with a smoothed trajectory generated by the smoothing.

The selected algorithm may be at least one trajectory smoothing algorithm of a t-fixed partition (TFP) algorithm and a k-ahead artificial arc (kAA) algorithm.

The TFP algorithm suggested herein may be an algorithm which partitions all movement points included in a trajectory into partition units, and returns a trajectory connecting movement points corresponding to the same order (for example, first, middle, last, and the like) in each partition as a smoothed trajectory.

In this example, a parameter t used in the TFP algorithm may be set to be a number of partitions into which movement points are partitioned or a number of movement points to be included in a single partition (that is, a partition size). For example, in a case of 5-FP, the processor 120 may partition movement points constituting the trajectory into “5” partitions or partition movement points such that “5” movement points are included in a single partition.

Further, the processor 120 may calculate a total number (for example, “23”) of movement points constituting the trajectory as a length of the trajectory, and adjust the parameter t in view of the length of the trajectory, thereby improving an outlier detection performance.

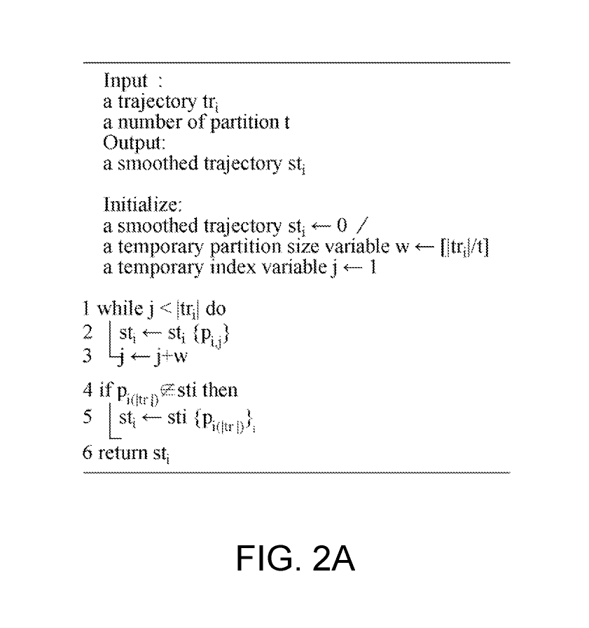

For example, according to a TFP algorithm of FIG. 2A, the processor 120 may smooth a trajectory trᵢ of the moving object 102 and output or return a smoothed trajectory stᵢ. In detail, the processor 120 may add a first movement point pᵢ₁, among the “23” movement points pᵢ₁ through pᵢ₂₃ included in the trajectory trᵢ to the smoothed trajectory stᵢ, add a movement point pᵢ₅ at a position increased from the first movement point pᵢ₁ by a partition size w(=4) to the smoothed trajectory stᵢ, add movement points pᵢ₉, pᵢ₁₃, pᵢ₁₇, and pᵢ₂₁ to the smoothed trajectory stᵢ by iteratively performing the above operations within a length Itril of the trajectory, add a movement point p_{i|tri|} (that is, pᵢ₂₃) at a last position in the trajectory trᵢ to the smoothed trajectory stᵢ if the last movement point pᵢ₂₃ is not included in the smoothed trajectory stᵢ, and return the smoothed trajectory.

Here, an input may be the trajectory trᵢ and the number of partitions t, and an output may be the smoothed trajectory stᵢ of which an initial value is set to “0”. The partition size w may be set to a value obtained by dividing the length |trᵢ| of the trajectory trᵢ by the number of partitions t, and an index variable j may be set to “1”.

That is, the processor 120 may partition the movement points constituting the trajectory into a plurality of partitions including a predetermined number of movement points based on the TFP algorithm, select predetermined n-th (n being a natural number) movement points respectively in the plurality of partitions, connect the selected movement points based on a movement direction of the object 102, thereby generating the smoothed trajectory. In this example, the processor 120 may generate the smoothed trajectory by further connecting movement points corresponding to a departure place and a destination, among the movement points constituting the trajectory.

For example, referring to FIG. 3, the processor 120 may partition the “23” movement points constituting the trajectory on the top into “6” partitions such that “4” movement points are included in each partition, and generate a smoothed trajectory by connecting movement points 301 through 306 which are at the first position of each partition. In this example, a movement point 307 at the last position in the sixth partition may be added to the smoothed trajectory. Through this, the processor 120 may match a start (departure place) and an end (destination) of the smoothed trajectory to those of the trajectory.

Further, the processor 120 may partition the movement points such that each partition may include a predetermined number (parameter t) of movement points (TFP-absolute algorithm), or partition the movement points such that each partition may include a number of movement points corresponding to a determined ratio with respect to a length of the trajectory data (TFP-relative algorithm). Further, the processor 120 may adjust the parameter “t” in view of the length of the trajectory, thereby improving an outlier detection performance.

For example, according to the TFP-absolute (t=“10”) algorithm, the processor 120 may partition “4” trajectories with different lengths of “100”, “50”, “25”, and “20” such that a predetermined number (“10”) of movement points are included in a single partition.

Further, according to the TFP-relative algorithm (t=“10%”), the processor 120 may partition “4” trajectories with different lengths of “100”, “50”, “25”, and “20” such that movement points corresponding to a determined ratio (“10%”) are included in a single partition. In this example, the “4” trajectories may respectively include “10”, “5”, “2”, and “2” movement points in a single partition.

As described above, the processor 120 may partition the movement points constituting the trajectory into partitions based on the partition size (the number of movement points included in a single partition) or the number of partitions. For example, the processor 120 may partition each of the “4” trajectories with the lengths of “100”, “50”, “25”, and “20” into “6” partitions, irrespective of the lengths.

Further, the kAA algorithm suggested herein may be an algorithm which returns a shortest path from a first movement point (departure place) to a last movement point (destination) as a smoothed trajectory, by applying a shortest path algorithm in a state in which a path (graph Gᵢ) to a predetermined number of movement points positioned in a movement direction (ahead) is generated, with respect to each movement point included in a trajectory.

A parameter “k” used in the kAA algorithm may be set to be the number of ahead movement points for which paths are to be generated. For example, in a case of “5-AA”, the processor 120 may find a shortest path from a departure place to a destination by applying the shortest path algorithm in a state in which paths from each movement point of a trajectory to “5” ahead movement points are generated.

For example, the processor 120 may return a smoothed trajectory stᵢ by smoothing a trajectory trᵢ based on the kAA algorithm of FIG. 2B. In detail, the processor 120 may generate edges (arcs) connecting each movement point pᵢₐ included in the trajectory trᵢ to “k” movement points ahead until a last node corresponding to the length of the trajectory trᵢ is reached and sum up distances distᵢ of the edges. Then, the processor 120 may find a shortest path from the first movement point (departure place) to the last movement point (destination) in the trajectory trᵢ, add movement points corresponding to vertices of the edges forming the shortest path to the smoothed trajectory stᵢ, and return the smoothed trajectory.

Here, an input may be the trajectory trᵢ and the number t of partitions, and an output may be the smoothed trajectory stᵢ, of which an initial value may be set to “0”. The path (graph) Gᵢ with respect to each movement point may be (Vᵢ, Eᵢ) including a vertex Vᵢ and an edge Eᵢ, and initial values of index variables a and b, the shortest path spᵢ, and a set of the distances distᵢ may be set to “0”.

In another example, the processor 120 may form, based on the kAA algorithm, arcs connecting each of the movement points constituting the trajectory to a predetermined number of movement points ahead according to the movement direction of the object 102, calculate a shortest path from a departure place to a destination, and connect movement point on the shortest path based on the movement direction of the object 102, thereby generating the smoothed trajectory.

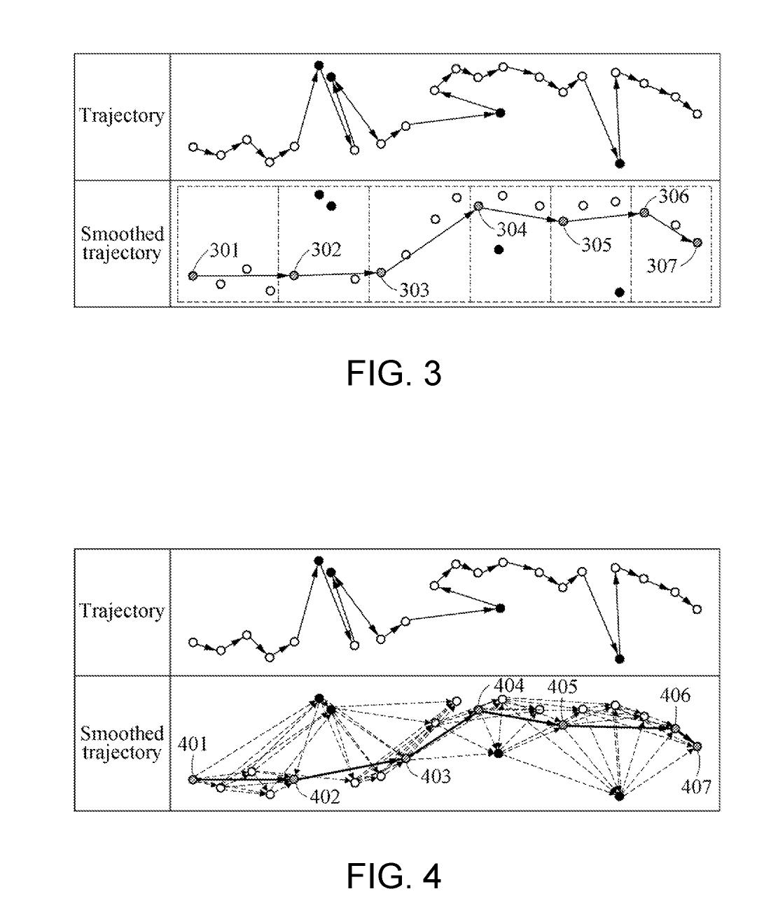

For example, referring to FIG. 4, the processor 120 may find, according to the kAA algorithm (in case of k=5), a shortest path from a movement point 401 of a departure place to a movement point 407 of a destination in a state in which paths to “5” ahead movement points are generated by connecting arcs (broken-line arrows) from each of the “23” movement points constituting the top trajectory to the “5” movement points, and generate an are forming the shortest path as a smoothed trajectory. That is, the processor 120 may generate, as the smoothed trajectory, solid-line arrows connecting “7” movement points 401 through 407, among the “23” movement points.

In this example, the processor 120 may form arcs from each of the movement points to a predetermined number (parameter k) of ahead movement points (kAA-absolute algorithm), or form arcs from each of the movement points to a number of movement points corresponding to a predetermined ratio with respect to the length of the trajectory data (trajectory) (kAA—relative algorithm).

For example, according to the kAA-absolute(k=5) algorithm, the processor 120 may connect arts from each movement point to “5” ahead movement points and find a shortest path, with respect to all “4” trajectories with different lengths of “100”, “50”, “25”, and “20”.

Further, according to the kAA-relative algorithm (t=10%), the processor 120 may connect arcs from each movement point to “10” front movement points and find a shortest path for the trajectory with the length of “100”, and connect arts from each movement point to “2” ahead movement points and find a shorted path for the trajectory with the length of “25”.

In this example, the processor 120 may adjust the parameter k in view of the length of the trajectory, thereby improves an outlier detection performance.

In some example embodiments, the interface 110 may receive the trajectory data in real time from the GPS 103 through the GPS receiver attached to the object 102. In this example, if the number of first movement points identified based on trajectory data exceeds the predetermined number, the processor 120 may calculate a shortest path among arcs connecting the first movement points, and calculate a shortest path step by step with respect to arcs connecting second movement points additionally identified each time new trajectory data is received subsequent to the trajectory data. The database 150 may retain the trajectory data received in real time.

For example, referring to FIG. 4, the processor 120 may generate arcs from the first movement point 401 to remaining “4” movement points, among “5” first movement points (corresponding to the movement points from 401 to 402) identified based on real-time positions of the object 102 received from the GPS 103 in a streaming environment, and find a shortest path from the first movement point 401 to the fifth movement point 402.

The, if subsequent “4” second movement points are received further, the processor 120 may generate arcs from the fifth movement point 402 respectively to the second movement points, and find a shortest path from the fifth movement point 402 to the ninth movement point 403.

That is, the processor 120 may generate arcs each time movement points are additionally identified based on trajectory data received in real time in a streaming environment, calculate shortest paths step by step, and generate arcs respectively included on the shortest path as a smoothed trajectory.

As described above, the processor 120 may find a shortest path step by step in a streaming environment. Thus, a computational complexity may decrease relatively when compared to an example of finding a shortest path with respect to all possible paths from a departure place to a destination using trajectory data input in a form of batch.

In an example, the trajectory data processing system 100 may further include the calculator 130.

The calculator 130 may calculates a compression rate of the smoothed trajectory with respect to the trajectory.

The calculator 130 may calculate, as the compression rate, a ratio of noise removed from the trajectory as the processor 120 generates the smoothed trajectory by removing noise (or outliers) through smoothing with respect to the trajectory.

That is, the calculator 130 may calculate, as the compression rate, a value obtained by dividing a value, obtained by subtracting the number of movement points included in the smoothed trajectory from the number of movement points included in the trajectory, by the number of movement points included in the trajectory.

That is, the calculator 130 may calculate the compression rate by subtracting, from “1”, the value obtained by dividing the number of movement points included in the smoothed trajectory (the length of the smoothed trajectory) by the number of movement points constituting the trajectory (the length of the trajectory), as expressed by Equation 1.

$$CR ( {st}_{i} , {tr}_{i} ) = 1 - \frac{\vert {st}_{i} \vert}{\vert {tr}_{i} \vert} \qquad [ Equation 1 ]$$

That is, according to Equation 1, the calculator 130 may calculate the compression rate by subtracting, from “1”, the value obtained by dividing the length of the smoothed trajectory by the length of the trajectory. Here, the length of the trajectory or the smoothed trajectory may be calculated as the number of movement points included in the corresponding trajectory or smoothed trajectory.

For example, referring to FIG. 3, according to the TFP algorithm, the processor 120 may generate a smoothed trajectory using remaining “7” movement points 301 through 307, excluding “16” movement points (noise, outliers) from the total of “23” movement points constituting the trajectory, and the calculator 130 may calculate a compression rate of the smoothed trajectory generated according to the TFP algorithm by subtracting, from “1”, a value (“7/23”) obtained by dividing the number (“7”) of movement points included in the smoothed trajectory by the number (“23”) of movement points constituting the trajectory.

Further, referring to FIG. 4, according to the kAA algorithm, the processor 120 may generate a smoothed trajectory using remaining “7” movement points 401 through 407, excluding “16” movement points (noise, outliers) from the total of “23” movement points constituting the trajectory, and the calculator 130 may calculate a compression rate of the smoothed trajectory generated according to the kAA algorithm by subtracting, from “1”, a value (“7/23”) obtained by dividing the number (“7”) of movement points included in the smoothed trajectory by the number (“23”) of movement points constituting the trajectory.

That is, when comparing the smoothed trajectory generated according to the TFP algorithm (refer to FIG. 3) and the smoothed trajectory generated according to the kAA algorithm (refer to FIG. 4), the smoothed trajectories each include “7” movement points equally although the movement points 303 and 306 are different from the movement points 403 and 406. Thus, the calculator 130 may calculate the compression rates of the smoothed trajectories as the same value.

Herein, a relatively high compression rate may indicate a relatively high smoothing performance. If the compression rates of the smoothed trajectories are equal, and thus the smoothing performances are equal, the processor 120 may choose an optimal trajectory smoothing algorithm to perform smoothing in view of computational complexities of trajectory smoothing algorithms or trajectory data collecting manners (batch and streaming).

For example, the processor 120 may generate a smoothed trajectory using the TFP algorithm which does not apply the shortest path algorithm and thus has a relatively low computational complexity if the number of movement points included in a trajectory exceeds a predetermined number (for example, “100”), or generate a partially smoothed trajectory by applying the kAA algorithm if trajectory data is collected in real time in a streaming environment.

The processor 120 may further provide the web application server with the compression rate as a performance result with respect to the smoothing, when providing the web application server with the smoothed trajectory.

In an example, the trajectory data processing system 100 may further include the detector 140 to determine an outlier in the smoothed trajectory.

The detector 140 may detect the outlier among movement points of the object constituting the trajectory based on at last one of a statistic value, a distance, and a density.

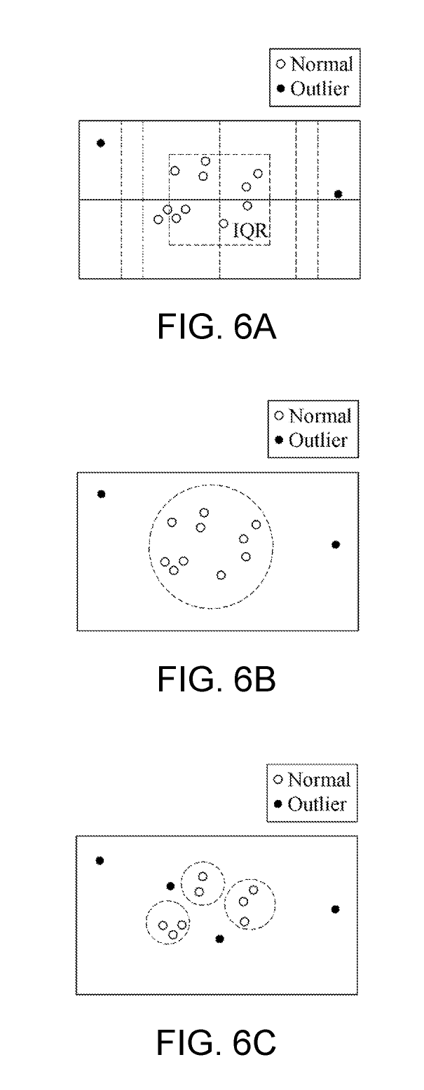

For example, referring to FIG. 6A, the detector 140 may detect filled movement points which are out of the statistic value as outliers based on a statistical technique (statistic value) such as the Tukey's Test.

Referring to FIG. 6B, the detector 140 may cluster movement points within a radius of 0.5 from a set reference point according to a clustering scheme such as DBSCAN and detect filled movement points which are out of the radius of 0.5 as outliers.

Referring to FIG. 6C, the detector 140 may estimate or detect, as outliers, filled movement points having a relatively low density when compared to neighboring movement points using a density-based outlier estimation algorithm such as the local outlier factor (LOF).

Here, the density may refer to an extent to which movement points are gathered together, and the LOF may be one of density-based outlier detecting algorithms in the field of machine learning, in detail, an algorithm which estimates an outlier using a principle that outliers have a relatively lower density than normal points around in a multidimensional space.

Herein, an outlier may refer to a movement point forming at least one of a small loop or a random jump among movement points constituting a trajectory.

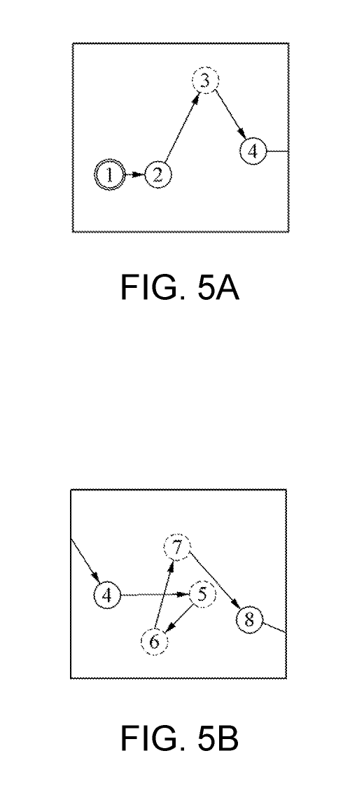

For example, referring to FIG. 5A, the detector 140 may detect, as an outlier forming a random jump, a third movement point marked at a point which is practically difficult to reach in “5” seconds from a second movement point, in a trajectory in which movement points of the object 102 are marked at predetermined intervals (for example, “5”-second intervals). Further, referring to FIG. 5B, the detector 140 may detect fifth, sixth, and seventh movement points forming a loop in the trajectory as outliers.

The processor 120 may connect remaining movement points excluding the outliers based on the movement direction of the object, thereby generating the smoothed trajectory.

That is, referring to FIGS. 5A and 5B, the processor 120 may generate the smoothed trajectory by connecting the first movement point to the second movement point, the second movement point to the fourth movement point, and the fourth movement point to the eighth movement point, excluding the third, fifth, sixth, and seventh movement points detected as the outliers, in the movement direction of the object (rightward).

The trajectory data processing system 100 may detect outliers in the smoothed trajectory from which minute noise is removed by smoothing the trajectory, thereby increasing the outlier detection performance more.

For example, referring to FIG. 3, when the processor 120 generates the smoothed trajectory (solid-line arrows of FIG. 3) by smoothing the trajectory, the detector 140 may easily detect outliers (filled movement points) in the smoothed trajectory based on at least one of a statistic value, a distance, and a density, and determine empty movement points excluded from the smoothed trajectory to be noise of the trajectory.

As described above, according to example embodiments, by smoothing a trajectory of a moving object by applying a selected trajectory smoothing algorithm to trajectory data in which positions of the object are recorded at predetermined intervals, a precision of the trajectory may increase, minute noise which is difficult to detect using an existing outlier detection algorithm may be minimized, and the precision of the trajectory may be sufficiently secured even in a streaming environment in which the trajectory data is received in real time.

FIGS. 2A and 2B illustrate examples of algorithms for smoothing trajectory data in a trajectory data processing system according to an example embodiment.

Referring to FIG. 2A, a trajectory data processing system may output or return a smoothed trajectory stᵢ by smoothing a trajectory trᵢ of an object based on a TFP algorithm.

The trajectory data processing system may add a first movement point pᵢ₁, among 23 movement points pᵢ₁ through pᵢ₂₃ included in the trajectory trᵢ, to the smoothed trajectory stᵢ.

Further, the trajectory data processing system may add, to the smoothed trajectory stᵢ, a movement point pᵢ₅ at a position increased by a partition size w(=4) from the first movement point pᵢ₁.

The trajectory data processing system may add movement points pᵢ₉, pᵢ₁₃, pᵢ₁₇, and pᵢ₂₁ to the smoothed trajectory stᵢ, by iteratively performing the above process within a length |trᵢ| of the trajectory.

In this example, the trajectory data processing system may add a movement point p_{i|tri|} (that is, pᵢ₂₃) at a last position in the trajectory trᵢ to the smoothed trajectory stᵢ if the last movement point pᵢ₂₃ is not included in the smoothed trajectory stᵢ, and then return the smoothed trajectory.

In the TFP algorithm of FIG. 2A, an input may be set to be the trajectory trᵢ and the number of partitions t, and an output may be the smoothed trajectory stᵢ of which an initial value is set to “O”. The partition size w may be set to be a value obtained by dividing the length Itri of the trajectory trᵢ by the number of partitions t, and an index variable j may be set to “1”.

Referring to FIG. 2B, the trajectory data processing system may return the smoothed trajectory stᵢ by smoothing the trajectory trᵢ according to the kAA algorithm.

In detail, the trajectory data processing system may generate a path between movement points by adding edges (arcs) connecting each movement point pᵢₐ included in the trajectory trᵢ to “k” ahead movement points, and sum up lengths of the edges, thereby calculating a distance distᵢ from the first movement point (departure place) of the trajectory trᵢ.

Then, the trajectory data processing system may calculate edges with which the distance distᵢ is minimized as a shortest path from the departure place to the destination of the trajectory trᵢ, and add movement points corresponding to vertices of the edges forming the shortest path to the smoothed trajectory stᵢ, and return the smoothed trajectory.

In the kAA algorithm of FIG. 2B, an input may be set to be the trajectory trᵢ and the number t of partitions, and an output may be the smoothed trajectory stᵢ, of which an initial value may be set to “0”. The path (graph) Gᵢ with respect to each movement point may be set to be (Vᵢ, Eᵢ) including a vertex Vᵢ and an edge Eᵢ, and initial values of index variables a and b, the shortest path spᵢ, and a set of distances distᵢ may be set to “0”.

FIG. 3 illustrates an example of smoothing trajectory data in a trajectory data processing system according to an example embodiment.

Referring to FIG. 3, a trajectory data processing system may partition movement points constituting a trajectory into a plurality of partitions including a predetermined number of movement points based on the TFP algorithm, select predetermined n-th (n being a natural number) movement points respectively in the plurality of partitions, connect the selected movement points based on a movement direction of an object, thereby generating a smoothed trajectory.

For example, the trajectory data processing system may partition “23” movement points constituting a trajectory on the top into “6” partitions such that “4” movement points are included in each partition.

The trajectory data processing system may generate a smoothed trajectory by connecting movement points 301 through 306 which are at the first position of each of the “6” partitions.

In this example, if a movement point 307 at the last position in the sixth partition is not included in the smoothed trajectory, the trajectory data processing system may add the last movement point 307 to the smoothed trajectory such that a start (departure place) and an end (destination) of the smoothed trajectory are matched to those of the trajectory.

That is, the trajectory data processing system may generate the smoothed trajectory connecting the “7” movement points 301 through 307, excluding noise from the “23” movement points constituting the trajectory, are connected, and easily detect filled movement points as outliers in the smoothed trajectory based on at least one of a statistic value, a distance, and a density.

FIG. 4 illustrates an example of smoothing trajectory data in a trajectory data processing system according to an example embodiment.

Referring to FIG. 4, a trajectory data processing system may form, based on the kAA algorithm, arcs connecting each of the movement points constituting the trajectory to a predetermined number of movement points ahead according to a movement direction of the object, calculate a shortest path from a departure place to a destination on the trajectory forming the arcs, and connect movement point on the shortest path based on the movement direction of the object, thereby generating the smoothed trajectory.

For example, according to the kAA algorithm (k=5), the trajectory data processing system may generate paths to “5” ahead movement points by connecting arcs (broken-line arrows) from each of the “23” movement points constituting the top trajectory to the “5” movement points.

Then, the trajectory data processing system may find a shortest path from a movement point 401 of a departure place to a movement point 407 of a destination, and generate a smoothed trajectory (solid-line arrows) including an arc (edge) forming the shorted path.

That is, the trajectory data processing system may generate a smoothed trajectory by connecting “7” movement points 401 through 407, excluding noise from the “23” movement points constituting the trajectory, and detect filled movement points in the smoothed trajectory as outliers based on at least one of a statistic value, a distance, and a density in the smoothed trajectory.

FIGS. 5A and 5B illustrate an example of detecting an outlier in a trajectory data processing system according to an example embodiment.

Referring to FIGS. 5A and 5B, a trajectory data processing system may detect, as an outlier, a movement point of an object forming at least one of a random jump and a small loop in a trajectory in which movement points of the object are marked at predetermined intervals (for example, “5”-second intervals).

Referring to the trajectory of FIG. 5A, the trajectory data processing system may detect a third movement point marked at a point which is practically difficult to reach in “5” seconds from a second movement point as an outlier forming a random jump. Further, referring to the trajectory of FIG. 5B, the trajectory data processing system may detect fifth, sixth, and seventh movement points forming a loop as outliers.

Then, the trajectory data processing system may generate the smoothed trajectory by connecting the first movement point to the second movement point, the second movement point to the fourth movement point, and the fourth movement point to the eighth movement point, excluding the third, fifth, sixth, and seventh movement points detected as the outliers, in the movement direction of the object (rightward).

FIGS. 6A through 6B illustrate an example of detecting an outlier in a trajectory data processing system according to an example embodiment.

Referring to FIGS. 6A through 6C, a trajectory data processing system may detect an outlier among movement points of an object constituting a trajectory based on at least one of a statistic value, a distance, and a density.

For example, referring to FIG. 6A, the trajectory data processing system may detect filled movement points which are out of the statistic value as outliers based on a statistical technique (statistic value) such as the Tukey's Test.

Referring to FIG. 6B, the trajectory data processing system may cluster movement points within a radius of 0.5 from a set reference point according to a clustering scheme such as DBSCAN and detect filled movement points which are out of the radius of 0.5 as outliers.

Referring to FIG. 6C, the trajectory data processing system may estimate or detect, as outliers, filled movement points having a relatively low density when compared to neighboring movement points using a density-based outlier estimation algorithm such as LOF.

As described above, the trajectory data processing system 100 may detect outliers in a smoothed trajectory from which minute noise is removed by smoothing a trajectory, thereby increasing an outlier detection performance.

Hereinafter, a flow of operation of the trajectory data processing system 100 according to an example embodiment will be described in detail.

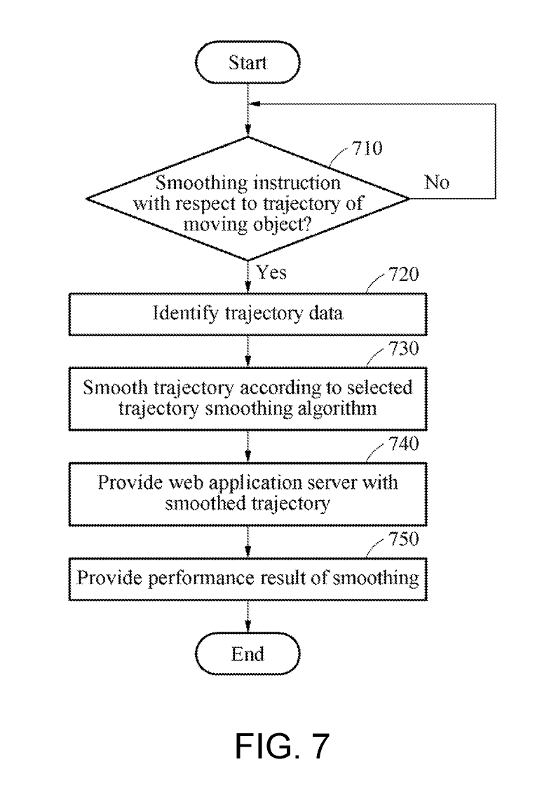

FIG. 7 is a flowchart illustrating a trajectory data processing method according to an example embodiment.

The trajectory data processing method may be performed by the trajectory data processing system 100 described above.

Referring to FIG. 7, in operation 710, the trajectory data processing system 100 may determine whether a smoothing instruction related to a trajectory of a moving object is generated by a web application server.

The smoothing instruction may refer to an instruction to generate a smoothed trajectory by removing noise included in the trajectory through smoothing. The smoothing instruction may be generated by the web application server which provides an administrator with a web page for monitoring a trajectory of an object. Herein, the object may include, for example, transportation such as a truck which transports goods.

In response to a determination that a smoothing instruction is generated, the trajectory data processing system 100 may identify trajectory data associated with the trajectory, in operation 720.

The trajectory data may be a dataset in which positions (for example, position coordinates, latitude, and longitude) measured at predetermined intervals are recorded in a batch as the object moves. Each data of the trajectory data may be recorded in a form of (time of measurement, latitude, longitude) at predetermine intervals (for example, “5”-second intervals).

Further, the trajectory data may be received (collected) in real time from a GPS through a GPS receiver attached to the object in a streaming environment and recorded in a DB.

As described above, the trajectory data processing system 100 may receive, from the web application server, the trajectory data in which positions of the moving object are recorded in a batch, or receive, immediately from the GPS, trajectory data including real-time positions of the object designated by the web application server in a streaming environment and configure a trajectory.

In operation 730, the trajectory data processing system 100 may smooth the trajectory by applying a selected algorithm to the trajectory data.

The selected algorithm may be at least one trajectory smoothing algorithm of a TFP algorithm and a kAA algorithm.

The TFP algorithm suggested herein may be an algorithm which partitions all movement points included in a trajectory into partition units, and returns a trajectory connecting movement points corresponding to the same order (for example, first, middle, last, and the like) in each partition as a smoothed trajectory.

Further, kAA algorithm suggested herein may be an algorithm which returns a shortest path from a first movement point (departure place) to a last movement point (destination) as a smoothed trajectory, by applying a shortest path algorithm in a state in which a path (graph Gᵢ) to a predetermined number of movement points positioned in a movement direction (ahead) is generated, with respect to each movement point included in a trajectory.

The trajectory data processing system 100 may selectively apply a trajectory smoothing algorithm based on computational complexities of trajectory smoothing algorithms or trajectory data collecting manners (batch or streaming).

For example, the trajectory data processing system 100 may generate a smoothed trajectory using the TFP algorithm which does not apply the shortest path algorithm and thus has a relatively low computational complexity if the number of movement points included in a trajectory exceeds a predetermined number (for example, “100”), or generate a partially smoothed trajectory by applying the kAA algorithm if trajectory data is collected in real time in a streaming environment.

In operation 740, the trajectory data processing system 100 may provide the web application server with the smoothed trajectory generated by the smoothing and visualize the smoothed trajectory. In operation 750, the trajectory data processing system 100 may further provide the web application server with a compression rate of the smoothed trajectory with respect to the trajectory as a performance result with respect to the smoothing, when providing the web application server with the smoothed trajectory.

For example, the trajectory data processing system 100 may calculate, as the compression rate, a ratio of noise removed from the trajectory as the smoothed trajectory is generated by removing noise (or outliers) through smoothing with respect to the trajectory.

That is, the calculator 130 may calculate, as the compression rate, a value obtained by dividing a value, obtained by subtracting the number of movement points included in the smoothed trajectory (the length of the smoothed trajectory) from the number of movement points included in the trajectory (the length of the trajectory), by the number of movement points included in the trajectory (the length of the trajectory).

In other words, the calculator 130 may calculate the compression rate by subtracting, from “1”, the value obtained by dividing the length of the smoothed trajectory by the length of the trajectory, as expressed by Equation 1.

Since a relatively high compression rate may indicate a relatively high smoothing performance, the trajectory data processing system 100 may further provide the web application server with the compression rate as the performance result, and provide the web application server with a compression rate with respect to a change in parameter used in the trajectory smoothing algorithm or a graph related to an accuracy of smoothed trajectory of each trajectory smoothing algorithm.

As described above, according to example embodiments, by smoothing a trajectory of a moving object by applying a selected trajectory smoothing algorithm to trajectory data in which positions of the object are recorded at predetermined intervals, a precision of the trajectory may increase.

According to example embodiments, by smoothing a trajectory, minute noise which is difficult to detect using an existing outlier detection algorithm may be minimized.

According to example embodiments, by applying an outlier detection algorithm after a trajectory is smoothed, an outlier detection performance may improve more.

According to example embodiments, a trajectory of a moving object may be precisely identified even in a streaming environment in which trajectory data related to positions of the object is received in real time.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A trajectory data processing method, comprising:
in response to a smoothing instruction related to a trajectory of a moving object being generated by a web application server,
identifying trajectory data associated with the trajectory;
smoothing the trajectory by applying a selected algorithm to the trajectory data; and
providing the web application server with a smoothed trajectory generated by the smoothing,
wherein the smoothing comprises:
partitioning movement points constituting the trajectory into a plurality of partitions including a predetermined number of movement points; and
generating the smoothed trajectory by selecting predetermined n-th (n being a natural number) movement points respectively in the plurality of partitions and connecting the selected movement points based on a movement direction of the object.

2. The trajectory data processing method of claim 1, wherein the partitioning comprises:
partitioning the movement points such that each of the partitions includes a predetermined number (parameter t) of movement points; or
partitioning the movement points such that each of the partitions includes a number of movement points corresponding to a determined ratio with respect to a length of the trajectory data.

3. The trajectory data processing method of claim 1, wherein the generating comprises generating the smoothed trajectory by further connecting movement points corresponding to a departure place and a destination, among the movement points constituting the trajectory.

4. The trajectory data processing method of claim 1, wherein the smoothing further comprises:
forming arcs connecting each of movement points constituting the trajectory to a predetermined number of movement points ahead based on a movement direction of the object;
calculating a shortest path from a departure place to a destination in a trajectory forming the arcs; and
generating the smoothed trajectory by connecting movement points on the shortest path based on the movement direction of the object.

5. The trajectory data processing method of claim 4, wherein the forming comprises:
forming arcs from each of the movement points to a predetermined number (parameter k) of movement points ahead; or
forming arcs from each of the movement points to a number of movement points corresponding to a determined ratio with respect to a length of the trajectory data.

6. The trajectory data processing method of claim 4, wherein, in response to the trajectory data being received in real time from a global positioning system (GPS) through a GPS receiver attached to the object, the smoothing further comprises:
calculating a shortest path among arcs respectively connecting first movement points identified base on the trajectory data, if a number of the first movement points exceeds the predetermined number; and
calculating shortest paths step by step with respect to arcs respectively connecting second movement points additionally identified each time new trajectory data is received subsequent to the trajectory data.

7. The trajectory data processing method of claim 1, wherein the identifying comprises receiving, from the web application server, the trajectory data in which positions measured at predetermined intervals are recorded as the object moves, and configuring the trajectory to be smoothed to include movement points identified based on the trajectory data.

8. The trajectory data processing method of claim 1, further comprising:
calculating a compression rate of the smoothed trajectory with respect to the trajectory by subtracting, from “1”, a value obtained by dividing a number of movement points included in the smoothed trajectory by a number of movement points constituting the trajectory; and
further providing the web application server with the compression rate as a performance result with respect to the smoothing, when providing the web application server with the smoothed trajectory.

9. The trajectory data processing method of claim 1, further comprising:
detecting a movement point forming at least one of a random jump and a small loop as an outlier based on at least one of a statistic value, a distance, and a density with respect to movement points of the object constituting the trajectory; and
generating the smoothed trajectory by connecting remaining movement points excluding the outlier based on a movement direction of the object.

10. A trajectory data processing system, comprising:
in response to a smoothing instruction related to a trajectory of a moving object being generated by a web application server,
an interface configured to identify trajectory data associated with the trajectory; and
a processor configured to smooth the trajectory by applying a selected algorithm to the trajectory data, and provide the web application server with a smoothed trajectory generated by the smoothing,
wherein the processor is configured to:
partition movement points constituting the trajectory into a plurality of partitions including a predetermined number of movement points, and
generate the smoothed trajectory by selecting predetermined n-th (n being a natural number) movement points respectively in the plurality of partitions and connect the selected movement points based on a movement direction of the object.

11. The trajectory data processing system of claim 10, wherein the processor is configured to form arcs connecting each of movement points constituting the trajectory to a predetermined number of movement points ahead based on a movement direction of the object, calculate a shortest path from a departure place to a destination in a trajectory forming the arcs, and generate the smoothed trajectory by connecting movement points on the shortest path based on the movement direction of the object.

12. The trajectory data processing system of claim 11, wherein the interface is configured to receive the trajectory data in real time from a global positioning system (GPS) through a GPS receiver attached to the object, and
the processor is configured to calculate a shortest path among arcs respectively connecting first movement points identified base on the trajectory data, if a number of the first movement points exceeds the predetermined number, and calculate shortest paths step by step with respect to arcs respectively connecting second movement points additionally identified each time new trajectory data is received subsequent to the trajectory data.

13. The trajectory data processing system of claim 10, further comprising:
a calculator configured to calculate a compression rate of the smoothed trajectory with respect to the trajectory by subtracting, from “1”, a value obtained by dividing a number of movement points included in the smoothed trajectory by a number of movement points constituting the trajectory,
wherein the processor is configured to further provide the web application server with the compression rate as a performance result with respect to the smoothing, when providing the web application server with the smoothed trajectory.

14. The trajectory data processing system of claim 10, further comprising:
a detector configured to detect a movement point forming at least one of a random jump and a small loop as an outlier based on at least one of a statistic value, a distance, and a density with respect to movement points of the object constituting the trajectory,
wherein the processor is configured to generate the smoothed trajectory by connecting remaining movement points excluding the outlier based on a movement direction of the object.
